(19) United States
(12) Patent Application Publication
(10) Pub. No.: US 2020/0005810 A1
(43) Pub. Date: Jan. 2, 2020

(54) ROBOT AND OPERATING METHOD THEREOF

(71) Applicant: LG ELECTRONICS INC., Seoul (KR)

(72) Inventor: Ji Hwan PARK, Seoul (KR)

(73) Assignee: LG ELECTRONICS INC., Seoul (KR)

(21) Appl. No.: 16/569,426

(22) Filed: Sep. 12, 2019

(30) Foreign Application Priority Data
Jul. 2, 2019 (KR) 10-2019-0079332

(51) Int. Cl. G10L 25/51; G10L 21/0232; H04R 1/40; H04R 3/00; G06T 13/40; G01S 11/14; G01S 3/803

(52) U.S. Cl. CPC G10L 25/51; G10L 21/0232; H04R 1/406; G01S 3/803; G06T 13/40; G01S 11/14; H04R 3/005

(57) ABSTRACT

A robot which executes a mounted artificial intelligence (AI) algorithm and/or machine learning algorithm and is capable of communicating with other electronic devices and external servers in a 5G communication environment and an operating method thereof. The robot includes a distance sensing sensor, an input unit which includes a plurality of microphones and is for inputting an audio signal, an output unit which includes a display, and a processor which obtains a sound of a base sound source disposed within a sensible range of the distance sensing sensor through a plurality of microphones to process the sound. The processor measures the distance between the robot and the base sound source using the distance sensing sensor, calculates reference CDR information corresponding to the measured distance information, and estimates CDR information of a sound corresponding to the distance from the robot based on the calculated reference CDR information.

### CROSS-REFERENCE TO RELATED APPLICATION

Pursuant to 35 U.S.C. § 119(a), this application claims the benefit of earlier filing date and right of priority to Korean Patent Application No. 10-2019-0079332, filed on Jul. 2, 2019, the contents of which are hereby incorporated by reference herein in its entirety.

### BACKGROUND

### 1. Technical Field

The present disclosure relates to a robot which estimates a distance from a sound source and an operating method thereof.

### 2. Description of Related Art

A robot is a device which automatically handles works by its own ability and in recent years, fields to which robots are applied are more extended to develop medical robots, guide robots, and aerospace robots. Further, home robots which can be applied in general households are actively being developed.

A service robot disclosed in a related art 1 is connected to a server via a network to transmit voice data to the server, estimates a direction of a sound source using a plurality of voice recognition microphones, and transmits information on the estimated sound source direction to the server.

However, the service robot estimates a direction where the sound source is generated, with respect to the service robot, but the service robot has a limitation that it cannot perform sound source recognition for providing various services to users.

A home robot disclosed in a related art 2 receives a voice signal through a plurality of microphones and estimates a sound source generation position corresponding to the received voice signal.

However, even though the related art 2 simply mentioned that positions of a home robot and a person who generates a sound source are estimated using a plurality of microphones, a specific implementing method therefor is not disclosed.

### SUMMARY OF THE INVENTION

An object to be achieved by the present disclosure is to provide a robot which can more quickly provide various services to a user by estimating a distance between a sound source (user) which is approaching from a place which is out of sight and a robot with high accuracy.

Another object to be achieved by the present disclosure is to provide a method which estimates a distance from a robot only using an input sound without using a distance sensor.

Still another object to be achieved by the present disclosure is to provide a method which performs interaction with a sound source when the sound source which is out of a photographic range approaches the robot in a predetermined distance.

Still another object to be achieved by the present disclosure is to provide a method which when sounds are simultaneously generated from a plurality of sound sources, obtains a sound of the closest sound source.

Technical objects to be achieved in the present invention are not limited to the aforementioned-technical objects, and other not-mentioned technical objects will be obviously understood by those skilled in the art from the description below.

In order to achieve the above-described objects, according to an aspect of the present disclosure, when only reference coherent to diffuse power ratio (CDR) information is calculated, a distance from a sound source may be estimated only using a plurality of microphones.

Specifically, the robot includes a distance sensing sensor, an input unit which includes a plurality of microphones and is for inputting an audio signal, an output unit which includes a display, and a processor which allows a sound of a base sound source disposed within a sensible range of the distance sensing sensor to be input through the plurality of microphones. The processor measures the distance between the robot and the base sound source using the distance sensing sensor, calculates reference CDR information corresponding to the measured distance information, and estimates CDR information of a sound corresponding to the distance from the robot based on the calculated reference CDR information.

The processor receives a sound generated from a predetermined sound source which is out of a photographic range of a robot through the plurality of microphones, calculates CDR information of the input sound, estimates the position of a predetermined sound source based on the calculated CDR information and the estimated CDR information, and performs a specific interaction operation when the estimated position of the predetermined sound source is within an interaction range of the robot.

Here, the input unit includes a camera and the processor may change a photographing direction of the camera so that the predetermined sound source enters the photographic range of the robot.

In order to achieve the above-described objects, according to an aspect of the present disclosure, an operating method of a robot includes: receiving a sound generated a base sound source located in a sensible range of the robot through a plurality of microphones; calculating reference coherent to diffuse power ratio (CDR) information corresponding to measured distance information when the distance between the base sound source and the robot is measured; and estimating CDR information of a sound corresponding to a distance from the robot, based on the calculated reference CDR information.

The operating method may further include: receiving a sound generated from a predetermined sound source which is out of a photographic range of the robot through the plurality of microphones; calculating CDR information of the input sound; estimating a position of the predetermined sound source based on the calculated CDR information and the estimated CDR information; and performing a specific interaction operation when the estimated position of the predetermined sound source is within an interaction range of the robot.

The performing of a specific interaction operation may include changing a photographing direction of the robot so that the predetermined sound source enters the photographic range of the robot.

The performing of a specific interaction operation may include when the sound source enters within the photographic range, outputting a sound or an image for response to the predetermined sound source.

The operating method may further include: setting at least one area of a near field area NFA where interaction with the sound source is performed, a sound tracking area STA where the sound of the sound source is tracked, and a far field area FFA with respect to the robot, based on the distance information from the robot.

The operating method may further include: determining a sound output intensity corresponding to the respective areas, when it is estimated that the sound source is located in one of the areas, based on the CDR information of the sound generated from the sound source.

The operating method may further include: holding the operation of tracking the sound of the sound source when it is estimated that the sound source is located in the FFA, based on the CDR information of the sound generated from the sound source.

The operating method may further include: tracking the sound of the sound source when it is estimated that the sound source moves from the FFA to the STA.

The operating method may further include: performing an operation for interacting with the sound source when it is estimated that the sound source moves from the STA to the NFA.

The operating method may further include: generating a sound map which reflects a distance from one or more sound sources based on the distance information from the robot; and updating the sound map based on the changed position when the position of the robot is changed.

In order to achieve the above-described objects, according to an aspect of the present disclosure, an operating method of a robot includes: receiving a sound of a base sound source in a first position within a sensible range of the robot through a plurality of microphones; calculating first reference coherent to diffuse power ratio (CDR) information corresponding to distance information measured between the base sound source in the first position and the robot; receiving a sound of the base sound source in a second position through the plurality of microphones when the base sound source moves to the second position; calculating second reference coherent to diffuse power ratio (CDR) information corresponding to distance information measured between the base sound source in the second position and the robot; and estimating CDR information of a sound corresponding to a distance from the robot, based on the calculated first and second reference CDR information.

According to various exemplary embodiments of the present disclosure, the following effects can be derived.

First, a robot which precisely estimates a distance from a sound source only using a plurality of microphones is provided so that a distance from the sound source which is approaching from a place which is out of sight may be estimated with high accuracy and various services may be more quickly provided to the user. Therefore, the user's convenience may be improved.

Second, when a sound source which is out of the photographic range approaches the robot, an appropriate interaction may be performed by the robot so that the user's convenience may be improved.

Third, when sounds are simultaneously generated from a plurality of sound sources, the loss of the sound may be prevented so that the processing accuracy may be improved, and the user's convenience may be improved.

### BRIEF DESCRIPTION OF THE DRAWINGS

The above and other aspects, features, and advantages of the present disclosure will become apparent from the detailed description of the following aspects in conjunction with the accompanying drawings, in which:

FIG. 1 is a view illustrating an outer appearance of a robot according to an exemplary embodiment of the present disclosure;

FIG. 2 is a view illustrating a plurality of microphones disposed in a robot according to an exemplary embodiment of the present disclosure as virtually seen from an upper portion;

FIG. 3 is a block diagram illustrating a configuration of a robot according to an exemplary embodiment of the present disclosure;

FIG. 4 is a view for explaining a method of calculating CDR information of a sound generated from a base sound source within a sensible range according to an exemplary embodiment of the present disclosure;

FIG. 5 is a sequence diagram illustrating a method of extracting CDR information of a sound based on a reference CDR according to an exemplary embodiment of the present disclosure;

FIGS. 6 and 7 are sequence diagrams illustrating an operating method of a robot based on a position of a sound source according to an exemplary embodiment of the present disclosure;

FIGS. 8 to 10 are views for explaining a process of updating a sound map when a position of a robot according to an exemplary embodiment of the present disclosure is changed;

FIGS. 11 and 12 are views for explaining an operation of a robot when a sound source which is out of a photographic range approaches the robot according to an exemplary embodiment of the present disclosure; and

FIG. 13 is a view for explaining an operation of a robot which selects and uses a sound in a short distance among a plurality of sounds.

### DETAILED DESCRIPTION

Advantages and features of the present disclosure and methods for achieving them will become apparent from the descriptions of aspects herein below with reference to the accompanying drawings. However, the present disclosure is not limited to the aspects disclosed herein but may be implemented in various different forms. The aspects are provided to make the description of the present disclosure thorough and to fully convey the scope of the present disclosure to those skilled in the art. It is to be noted that the scope of the present disclosure is defined only by the claims.

The shapes, sizes, ratios, angles, the number of elements given in the drawings are merely exemplary, and thus, the present disclosure is not limited to the illustrated details. Like reference numerals designate like elements throughout the specification.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Hereinafter, embodiments disclosed the present specification will be described in detail with reference to the accompanying drawings, and the same or similar components are denoted by the same or similar references, and repeated description thereof will be omitted. In describing the exemplary embodiments disclosed in the present specification, when it is determined that a detailed description of a related publicly known technology may obscure the gist of the exemplary embodiment disclosed in the present specification, the detailed description thereof will be omitted.

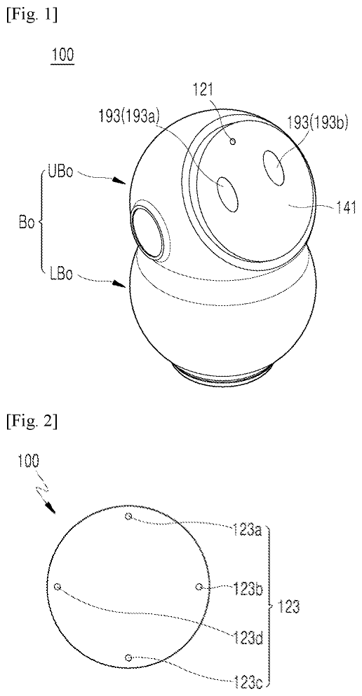

FIG. 1 is a view for explaining an outer appearance of a robot 100 according to an exemplary embodiment of the present disclosure.

The robot 100 which may communicate with various external devices may be disposed in a predetermined space (for example, home, hospitals, offices, or etc.). The robot 100 may include a body Bo and the body Bo may include an upper body UBo which forms an upper portion of the body Bo and a lower body LBo which forms a lower portion of the body. The body Bo may perform a tilting operation in a left-right direction or a tilting operation in a front-rear direction.

The upper body UBo includes a display 141 to display various contents or display an interface for providing a video call. Further, the display 141 may perform an operation for interaction with a user. For example, the display 141 may virtually display oval or circular items 193a and 193b similar to a shape of the user's eye and perform an interaction operation such as wink or flicker. Therefore, a more-friendly operation to the user may be performed by the robot 100.

A camera 121 may be disposed in one area of the display 141 and the camera 121 may be used to photograph or recognize the user. The camera 121 is implemented such that an upper body UBo rotates to photograph and recognize objects disposed in all directions.

According to an exemplary embodiment, the camera 121 includes a distance sensor which autonomously senses a distance to measure a distance from an object disposed in a photographing direction of the camera 121.

The robot 100 may be disposed to be fixed to a predetermined area. As an alternative embodiment, the robot 100 includes a mobile module to move to a desired direction or an input direction.

FIG. 2 is a plan view illustrating a plurality of microphones according to an exemplary embodiment of the present disclosure which is disposed in a predetermined area of the robot 100 as seen from an upper portion.

The robot 100 may include a plurality of microphones 123a to 123d in a predetermined area of the upper body UBo or the lower body LBo. The plurality of microphones 123a to 123d may be disposed in the directions of north, south, east, and west. The plurality of microphones 123a to 123d may be represented as a microphone array. As selective embodiments, the plurality of microphones may be two, three, or five or more microphones.

The robot 100 may perform sound source localization using the plurality of microphones 123a to 123d. The sound source localization is performed to estimate a direction of the sound source. Therefore, a direction of the sound source with respect to the robot 100 may be estimated using time differences among sounds input to the plurality of microphones 123a to 123d. Here, the sound source is an object which generates a sound and includes electronic devices, human, animals, or etc.

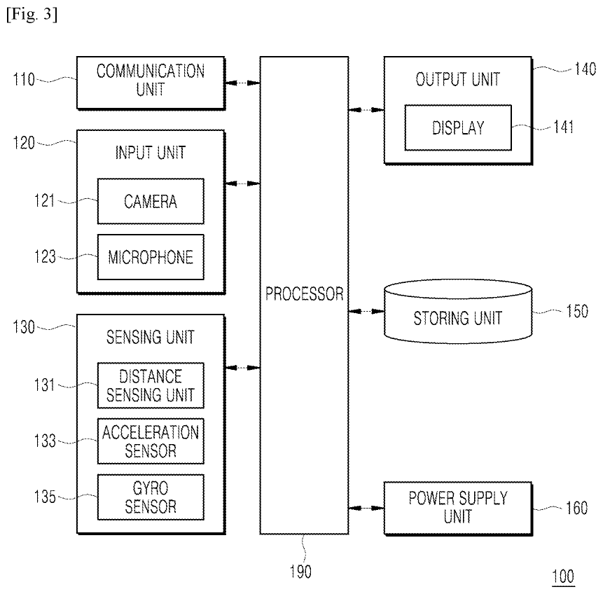

Hereinafter, components of the robot 100 will be described with reference to FIG. 3. The robot 100 may include a communication unit 110, an input unit 120, a sensing unit 130, an output unit 140, a storing unit 150, a power supply unit 160, and a processor 190. Components illustrated in FIG. 3 are not essential for implementing the robot 100 so that the robot 100 described in this specification may include more components or fewer components than the above-described components.

First, the communication unit 110 is a module for performing communications between the robot 100 and one or more communication devices. When the robot 100 is disposed in a general home, the robot 100 may configure a home network with a communication device (for example, a refrigerator, a washing machine, an internet protocol television (IPTV), a Bluetooth speaker, an artificial intelligence (AI) speaker, a mobile terminal, or etc.).

The communication unit 110 may include a mobile communication module and a near field communication module.

First, the mobile communication module may transmit and receive a wireless signal with at least one of a base station, an external terminal, and a server on a mobile communication network constructed in accordance with technical standards or communication schemes for the mobile communication (for example, global system for mobile communication (GSM), code division multi access (CDMA), CDMA2000, enhanced voice-data optimized or enhanced voice-data only (EV-DO), wideband CDMA (WCDMA), high speed downlink packet access (HSDPA), high speed uplink packet access (HSUPA), long term evolution (LTE), long term evolution-advanced (LTE-A), or a 5G (generation)).

The communication unit 110 includes a mobile communication module which supports 5G communication to transmit data at 100 Mbps to 20 Gbps so that a large amount of videos may be transmitted to various devices. Further, the communication unit 110 is driven at a low power so that the power consumption may be minimized.

Further, the communication unit 110 may include a near field communication module. Here, the near field communication module is provided for short range communication and supports the short range communication using at least one of Bluetooth™, radio frequency identification (RFID), infrared data association (IrDA), ultra wideband (UWB), ZigBee, near field communication (NFC), Wireless-Fidelity (Wi-Fi), Wi-Fi Direct, and wireless universal serial bus (Wireless USB).

Further, the communication unit 110 may support various things intelligence communication (for example, Internet of things (IoT), Internet of everything (IoE), internet of small things (IoST), etc.) and also support machine to machine (M2M) communication, vehicle to everything (V2X) communication, and device to device (D2D) communication.

The input unit 120 may include a camera 121 or an image input unit for inputting an image signal, a microphone 123 or an audio input unit for inputting an audio signal, and a user input unit (for example, a touch key, a mechanical key, or etc.) which receives information from a user. The input unit 120 may include a plurality of cameras 121 and a plurality of microphones 123 and specifically, may include three or more microphones 123. In the present specification, it is described that four microphones 123 are provided, but the exemplary embodiment is not limited thereto. In some implementations, the input unit 120 may be implemented inputter or input interface. In some implementations, the input unit 120 comprises at least one of inputter or consists of at least one of inputter. In some implementations, the input unit 120 may be configured to input data and signals.

The sensing unit 130 may include one or more sensors which sense at least one of information in the robot 100, surrounding environment information around the robot 100, and user information. For example, the sensing unit 130 may include at least one of a distance sensing sensor 131 (for example, a proximity sensor, a passive infrared (PIR) sensor, or a Lidar sensor), a weight sensing sensor, an illumination sensor, a touch sensor, an acceleration sensor 133, a magnetic sensor, a G-sensor, a gyroscope sensor 135, a motion sensor, an RGB sensor, an infrared (IR) sensor, a finger scan sensor, an ultrasonic sensor, an optical sensor (for example, a camera 121), a microphone 123, a battery gauge, an environment sensor (for example, a barometer, a hygrometer, a thermometer, a radiation sensor, a thermal sensor, or a gas sensor), and a chemical sensor (for example, an electronic nose, a healthcare sensor, or a biometric sensor). In the meantime, the robot 100 disclosed in the present specification may combine and utilize information sensed by at least two sensors from the above-mentioned sensors.

Here, the sensing unit 130 may include an inertial measurement unit (IMU) sensor and the IMU sensor may include the acceleration sensor 133, the gyro sensor 135, an angular velocity sensor, a terrestrial magnetism sensor, an altitude sensor, etc. to measure a velocity, a direction, a gravity, acceleration, etc. of the moving object. The IMU sensor may sense the movement of the robot 100.

The output unit 140 is provided to generate outputs related to vision, auditory sense, or tactile sense and may include at least one of a display 141 (a plurality of displays can be applied), one or more light emitting diodes, a sound output unit, and a haptic module. The display 141 forms a mutual layer structure with a touch sensor or is formed integrally to be implemented as a touch screen. The touch screen may serve as a user input unit which provides an input interface between the robot 100 and the user and provides an output interface between the robot 100 and the user. The output unit 140 comprises at least one of a outputter or consists of at least one of a outputter. In some implementations, the output unit 140 may be implemented outputter or output interface. In some implementations, the output unit 140 comprises at least one of outputter or consists of at least one of outputter. In some implementations, the output unit 140 may be configured to output data and signals.

The storing unit 150 stores data which supports various functions of the robot 100. The storing unit 150 may store a plurality of application programs (or applications) driven in the robot 100, and commands and data for operations of the robot 100. At least some of application programs may be downloaded from the external server through wireless communication. Further, the storing unit 150 may store information on a user who performs the interaction with the robot 100. The user information may be used to identify a recognized user.

Further, the storing unit 150 may store information required to perform an operation using artificial intelligence, machine learning, and an artificial neural network which will be described below.

The power supply unit 160 is applied with external power and internal power to supply the power to each component of the robot 100, under the control of the processor 190. The power supply unit 160 includes a battery and the battery may be an embedded battery or a replaceable battery. The battery may be charged by a wired or wireless charging method and the wireless charging method may include a self-induction method or a magnetic resonance method.

The processor 190 is a module which controls the components of the robot 100 and may obtain a sound of a sound source which has a predetermined distance from the robot 100 through the plurality of microphones 123. Here, the sound source is an object which generates a sound and may include electronic devices, human, animals, or etc..

When the human is assumed as a sound source, the processor 190 may receive a voice of a user within a distance which is recognizable by the distance sensing sensor 131 through the plurality of microphones 123. Here, the distance sensing sensor 131 may recognize a user in a proximate distance, but as an alternative embodiment, the distance sensing sensor may recognize a user in a long distance. A sound source within a sensible range of the distance sensing sensor 131 is considered as a base sound source, but according to the implemented example, the base sound source is not limited to the sensible range.

The processor 190 may measure a distance between the robot 100 and the base sound source using the distance sensing sensor 131 and calculate reference coherent to diffuse power ratio (CDR) information corresponding to the measured distance information. The base sound source is an object which serves as a reference for identifying correlation with distance information or CDR information with the sound source by the processor 190 and may include a device, human, animals, or etc. That is, CDR information of another sound source or a distance between another sound source and the robot may be estimated based on the CDR information of the base sound source.

Hereinafter, it will be described that the processor 190 calculates coherent to diffuse power ratio (CDR) information for a sound of the sound source. Here, the CDR information is a power rate of a coherent component with respect to a diffuse component and is represented by dB.

Intuitively, the CDR information may be represented by a power rate between a signal which is immediately input from the sound source to the microphones without being reflected and a signal which is reflected by an obstacle in the space to be input to the microphone. The robot 100 may determine a relative distance between the robot 100 and the sound source (object) based on the CDR information. Hereinafter, the CDR information will be described in detail under the assumption that a plurality of microphones (two microphones) is provided.

Each of the plurality of microphones may receive a reverberant signal and a noise signal and signals which are input to the plurality of microphones will be modeled by the following Equation 1.

xᵢ(t)=x_{i,coh}(t)+x_{i,diff}(t) [Equation 1]

Here, i is an index (for example, 1 and 2) of the microphones and a signal which is input to each of the microphones may be modeled by a sum of a coherent component and a diffuse component. The coherent component is a desired speech component, and the diffuse component is an undesired component and may include a reverberant signal and a noise signal which are diffused.

When a loss-free propagation is assumed in far-field and free-field situations, X_{2,coh}(t) may be derived by a simple time shift of X_{1,coh}(t). That is, since a wave front having a directivity reaches each microphone from a point source, the coherent component which is input to each microphone channel may be modeled with the same signal which is input with a time difference. This will be derived as represented in the following Equation 2.

x_{2,coh}(t)=x_{1,coh}(t−τ₁₂) [Equation 2]

Here, τ₁₂ represents a time difference of arrival (TDOA) of expected sounds between two microphones, and according to Equation 2, a spatial coherence between speech components expected between two microphones may be represented by the following Equation 3. The coherent component which is received through the plurality of microphone channels may be represented by one matrix by the following Equation 3 and may be implemented as a model having a time difference of τ₁₂. Here, f is a frequency.

Γ_{coh}(f)=exp(j2πfτ₁₂) [Equation 3]

Further, the diffuse component has a high correlation for the same microphone, so that a correlation coefficient is 1. However, in the case of different microphones, the correlation is low. The diffuse component which is input through the plurality of microphone channels to which the correlation is reflected may be implemented by one matrix, which is represented by Equation 4. Here, d is a distance between the microphones and c is a sound velocity.

$${Γ}_{diff} ( f ) = \frac{sin ( 2 π fd / c )}{2 π fd / c} \qquad [ Equation 4 ]$$

Here, Φ_{coh}(k,l) which is power spectra of the coherent component for a short period is the same for each of the microphone and the following Equation 5 may be established. This is the same for the diffuse component.

Φ_{coh}(k,l)=Φ_{1,coh}(k,l)=Φ_{2,coh}(k,l) [Equation 5]

In the power spectra Φ_{coh}(k,l) of the coherent component for a short period and power spectra Φ_{diff}(k,l) of the diffuse component for a short period, k indicates a k-th discrete Fourier Transform (DFT) bin and 1 indicates a l-th time frame.

Here, the CDR information may be derived by the following Equation 6. That is, CDR information has the same value for each microphone and the value may be established by a power ratio of the coherent component with respect to the diffuse component and a unit thereof may be represented by dB. The CDR information may be efficiently used.

$$CDR ( k , l ) = {CDR}_{1} ( k , l ) = {CDR}_{2} ( k , l ) = \frac{{Φ}_{coh} ( k , l )}{{Φ}_{diff} ( k , l )} \qquad [ Equation 6 ]$$

As described above, the processor 190 may measure a distance between the robot 100 and the base sound source by the distance sensing sensor 131.

The processor 190 calculates the reference CDR information corresponding to the measured distance information and may estimate the CDR information of the sound corresponding to the distance from the robot 100 based on the calculated reference CDR information.

After calculating the reference CDR information corresponding to the distance from the base sound source which is accurately recognized, when the processor 190 receives a sound of the base sound source or another sound source, the processor 190 may estimate how much the input sound is far from the robot 100. Therefore, the processor 190 may use the reference CDR information for auto calibration to estimate the CDR information of the sound.

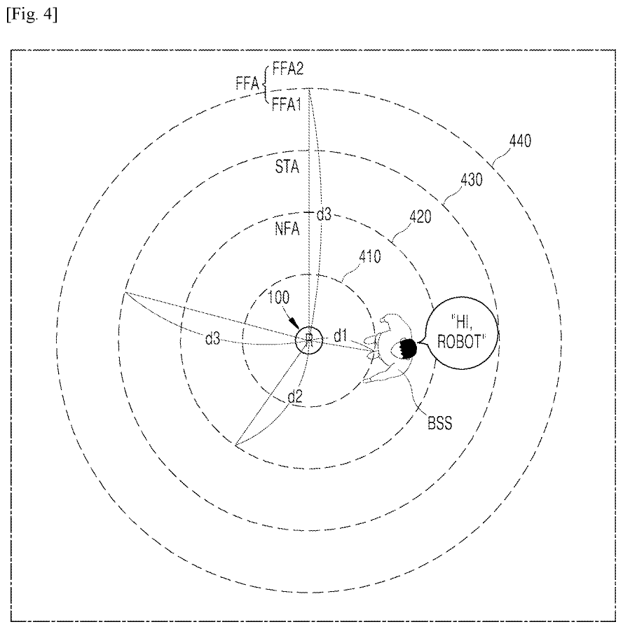

Hereinafter, various operating methods of the robot 100 will be described with reference to FIGS. 4 to 13.

FIG. 4 is a view for explaining a method of calculating CDR information of a sound generated from a base sound source BSS within a sensible range according to an exemplary embodiment of the present disclosure.

The processor 190 may virtually display external objects with the robot R 100 as a center. The external objects may be displayed on the display 141. The processor 190 may virtually display a first line 410, a second line 420, a third line 430, and a fourth line 440 with the robot 100 as a center. The lines 410 to 440 may be implemented as dotted line concentric circle, but the exemplary embodiment is not limited thereto.

Here, the process 190 may receive a sound (for example, “Hi, robot”) of the base sound source BSS through the plurality of microphones based on the distance information from the robot 100. The base sound source BSS is a sound source which serves as a reference.

The processor 190 may sense the base sound source BSS through the distance sensing sensor 131 and may set a near field area (NFA) where interaction with the base sound source BSS can be performed. The NFA is a short range field area and includes an area in the second line 420. However, a size of the area may be implemented in various sizes depending on the exemplary embodiment.

The processor 190 may set a sound tracking area STA which is an inner area of the third line 430 but is the outside of the NFA. The STA corresponds to an area where a sound of an external object is tracked, but the area may be implemented in various forms depending on the exemplary embodiment.

The processor 190 may set an outside area of the STA as a far field area (FFA). The FFA may be a long distance field area where the interaction is not performed while waiting for the sound tracking. In some implemented example, in the FFA, the robot 100 may perform various operations and the robot 100 may perform different operations in FFA1 and FFA2.

Here, the distance between the robot 100 and each line may be set to various distances. For example, it is understood that if d1 is 50 cm, d2 is 1 m which is twice d1, d3 is 2 m which is twice d2, and d4 is 3 m which is 1.5 times d3. The robot 100 may calculate the CDR information in the d1 to be 10 dB, and based on this, estimate that the CDR information in the d2 is 4 dB, the CDR information in the d3 is −2 dB, and the CDR information in the d4 is −5.5 dB. However, a reduction range of the sound pressure may be set in various ranges depending on a structure of a space, an obstacle, a medium, and an uttering point, the CDR information corresponding to the distance from the robot 100 may be estimated by calculating the reference CDR information with respect to the distance from the robot 100.

The processor 190 may estimate CDR information of a sound generated when a predetermined sound source is disposed in the vicinity of the robot 100 in a state in which a distance from the base sound source BSS is accurately measured. Even though it is difficult to accurately measure a distance from the sound source and the sound source is disposed in an area out of a photographic range of the camera 121, the processor 190 may estimate the distance from the sound source.

When it is estimated that the sound source is located in the FFA based on the CDR information of the sound generated from the sound source (for example, the base sound source or a predetermined sound source), the processor 190 may perform an operation of tracking the sound of the sound source.

When it is estimated that the sound source moves from the FFA to the STA, the processor 190 may perform an operation of tracking the sound of the sound source. According to an exemplary embodiment, the processor 190 may perform an operation of performing immediately interaction with the sound source in the STA, but the interaction may be more passive than that in the NFA. For example, the processor 190 may output only sounds without moving the camera 121.

When it is estimated that the sound source moves from the STA to the NFA, the processor 190 may perform an operation for interaction with the sound source. For example, the processor 190 may turn the camera 121 toward the sound source to allow items on the display 141 to react.

In order to more accurately estimate the CDR information, the processor 190 may receive a sound of the base sound source from a plurality of positions and calculate the plurality of reference CDR information based on the input sound.

Specifically, the processor 190 may receive the sound of the base sound source in a first position and a second position within the sensible range of the distance sensing sensor 131 through the plurality of microphones 123a to 123d, calculate the reference CDR information corresponding to distance information measured between the base sound source in the first position and the second position and the robot, and estimate the CDR information of the sound corresponding to the distance from the robot 100 based on the calculated reference CDR information. In this case, the CDR information of the predetermined sound and the distance from the robot 100 may be more accurately estimated.

Here, a single base sound source or a plurality of base sound sources may be implemented. When only one base sound source is provided, the base sound source may move from the first position to the second position and when the plurality of base sound sources is provided, the CDR information may be calculated from the base sound sources disposed in the first position and the second position.

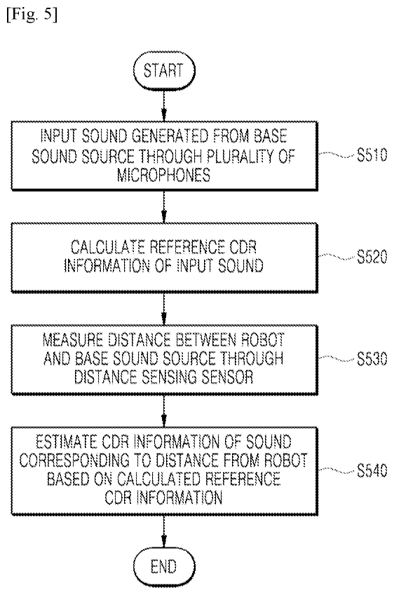

FIG. 5 is a sequence diagram illustrating a method of extracting CDR information of a sound based on a reference CDR according to an exemplary embodiment of the present disclosure and the sequence diagram corresponds to a time flowchart summarizing the above-described contents.

First, in step S510, the robot 100 receives a sound generated in a base sound source through a plurality of microphones.

In step S520, the robot 100 calculates reference CDR information of the input sound.

In step S530, the robot 100 measures a distance between the robot 100 and the base sound source using a distance sensing sensor.

In step S540, CDR information corresponding to a distance from the robot 100 is estimated based on the calculated reference CDR information.

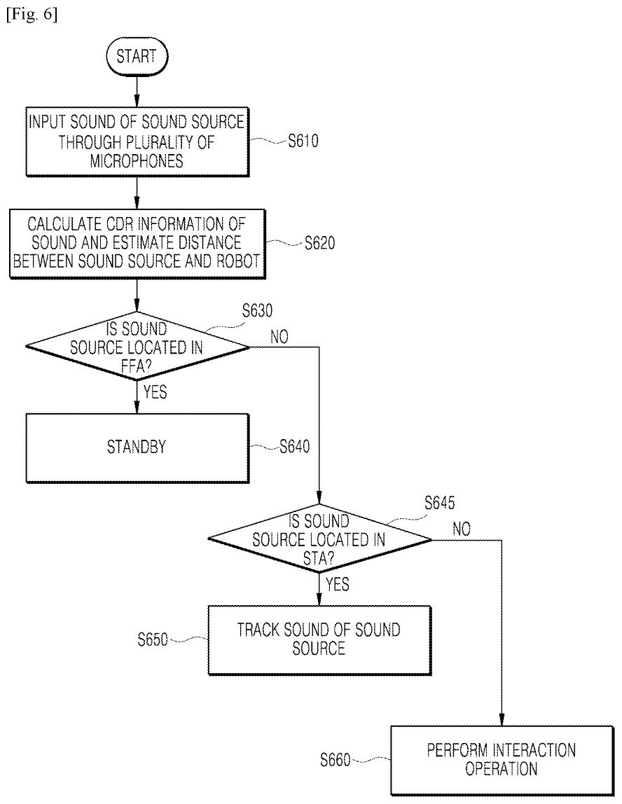

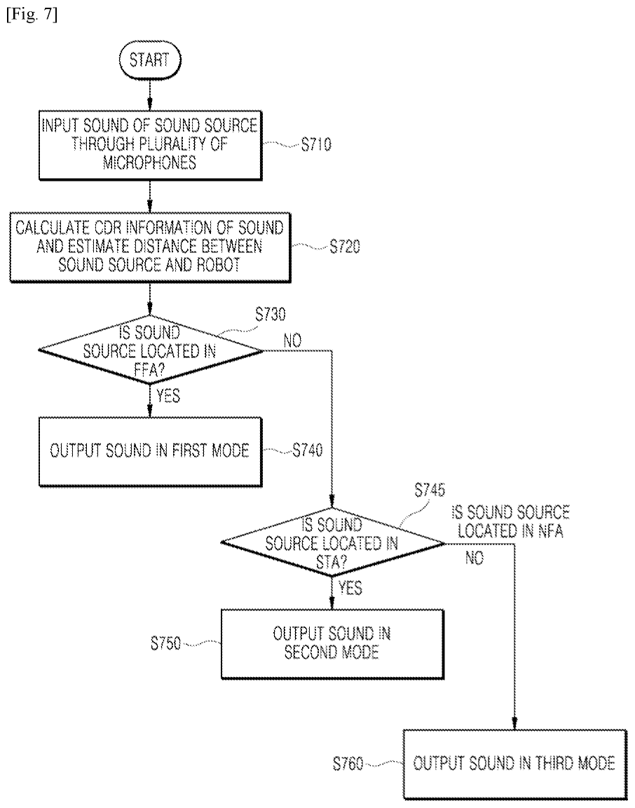

FIGS. 6 and 7 are sequence diagrams illustrating an operating method of a robot based on a position of a sound source according to an exemplary embodiment of the present disclosure, which will be described also with reference to FIG. 4.

As a common step of FIGS. 6 and 7, the robot 100 receives the sound of the sound source through the plurality of microphones in steps S610 and S710, calculates the CDR information of the base sound and estimates the distance between the sound source and the robot in steps S620 and S720.

First, in FIG. 6, when a predetermined sound source is located in the FFA in step S630, the robot 100 may be in a standby state in step S640. In some implemented examples, the robot 100 may perform operations required for sound tracking.

Next, when the sound source moves from the FFA to the STA in steps S630 and S645 (when the sound source is located in the STA), the sound tracking of the sound source is attempted in step S650. In some implemented examples, the robot 100 may perform a passive interaction operation.

Next, when the sound source moves from the STA to the NFA in step S645, interaction operation is performed in step S660.

Referring to FIG. 7, the robot 100 may determine a sound output intensity corresponding to the areas depending on the position of the sound source to output the sound. For example, when the sound source is disposed in the FFA in step S730, the robot 100 outputs the sound in a first mode in step S740.

Here, in order to communicate with a sound source disposed in a long distance, the robot 100 may set a relatively strongest output (for example, increase a volume by 6 dB and increase a pitch by 10%).

Next, when the sound source moves from the FFA to the STA in steps S730 and S745 (when the sound source is located in the STA), the sound is output in a second mode in step S750. Here, the second mode may be a setting in which the output is weaker than that of the first mode (for example, increase a volume by 3 dB and increase a pitch by 5%).

Next, when the sound source moves from the STA to the NFA in step S745, the sound may be output in a third sound mode in step S760.

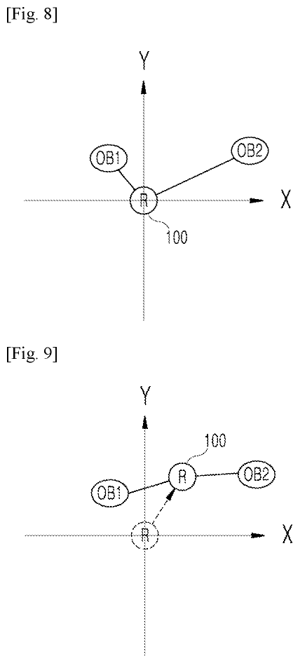

FIGS. 8 to 10 are views for explaining a process of updating a sound map when a position of a robot according to an exemplary embodiment of the present disclosure is changed.

Referring to FIG. 8, the robot 100 may generate a sound map with the robot 100 disposed at a center. OB2 is disposed in a first quadrant and OB1 is disposed in a second quadrant, with respect to the robot 100. For example, CDR information of OB2 may be 3 dB, DOA may be 45 degrees, CDR information of OB1 may be 10 dB and DOA may be 110 degrees.

The robot 100 may estimate distance information from the robot 100 based on the reference CDR so that positions of objects OB1 and OB2 which are sound sources may be specified with respect to the robot 100.

As illustrated in FIG. 9, when the robot 100 moves to one point of the first quadrant, the robot 100 may estimate the direction and the distance from the objects. For example, with regard to the robot 100, CDR information of OB2 may be 9 dB and the DOA may be 0 degree and CDR information of OB1 may be 3 dB and the DOA may be 210 degrees.

Here, the robot 100 may update the relation with objects OB1 and OB2 with a moved point as a center. By doing this, the sound map may be more easily updated as compared with an example which estimates only the direction of the objects.

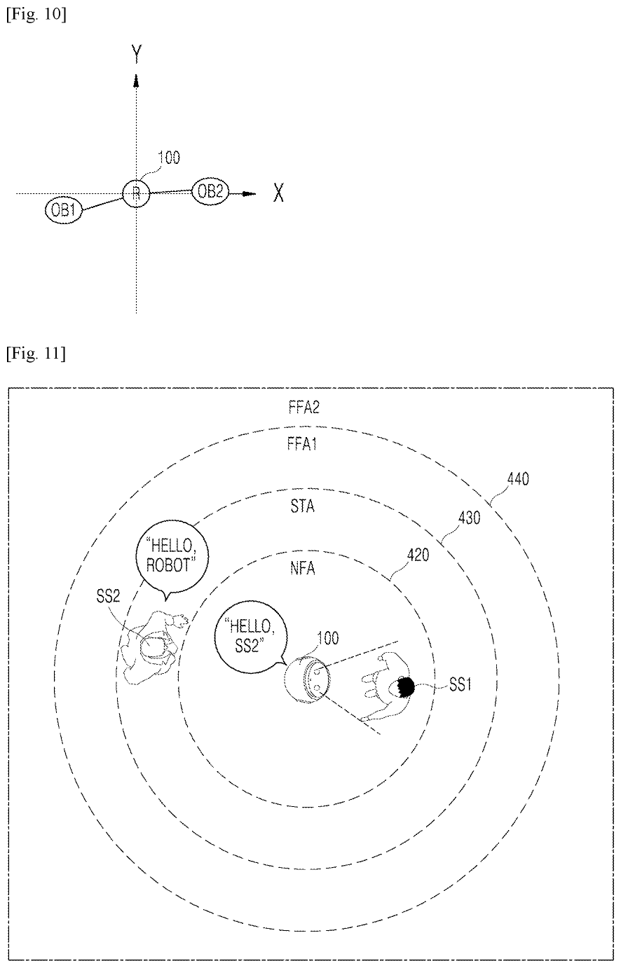

Referring to FIG. 10, the robot 100 may update the sound map with respect to the objects OB1 and OB2 and the robot 100.

Here, the processor 190 adjusts the IMU sensor so as not to be sensitive so that the erroneous sensing due to the movement of the robot 100 may be avoided. Specifically, the processor 190 uses an average value of the square of sensing values so that the sensing value which is suddenly changed is not immediately applied. That is, even though the value of the acceleration sensor 133 or the gyro sensor 135 is suddenly changed, not only a value having a sudden change is considered, but also a plurality of previous values is considered (for example, a mean square value is used) to prevent the erroneous sensing.

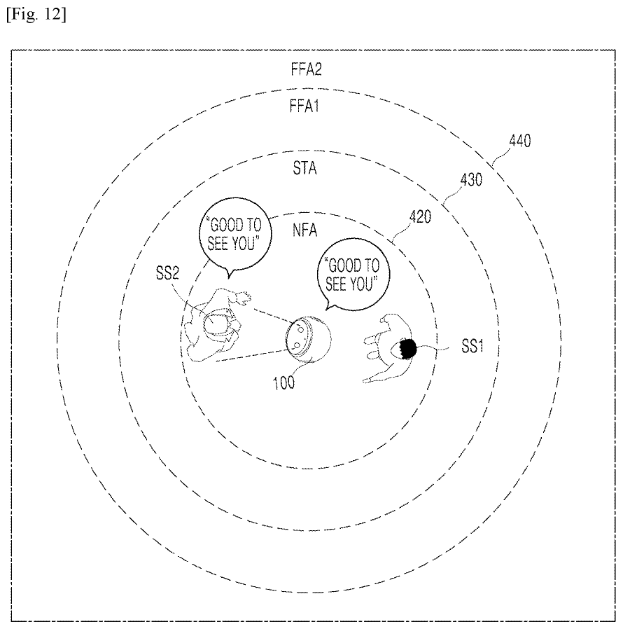

FIGS. 11 and 12 are views for explaining the operation of the robot when a sound source which is out of a photographic range approaches the robot according to an exemplary embodiment of the present disclosure.

The robot 100 is disposed in the NFA 420 (inside) which is an interaction area and performs the interaction with a first sound source SS1. The robot 100 may receive a sound (“Hello, robot”) of a second sound source SS2 disposed in STA which is out of the photographic range of the camera of the robot using a plurality of microphones.

By doing this, the robot 100 calculates the CDR information of the input sound. The robot 100 may estimate the position of the second sound source SS2 based on the estimated CDR information. Since the position of the second sound source SS2 is estimated to be STA, the robot 100 may perform the sound tracking. The robot 100 monitors the sound of the second sound source SS2 for a predetermined time period and when the second sound source SS2 enters an NFA in which interaction is available as illustrated in FIG. 12, the robot 100 may hold the sound tracking operation and perform interaction (for example, utters a sound “Good to see you”) with the second sound source SS2.

Specifically, when the second sound source SS2 enters the NFA, the robot 100 may set the photographing direction of the camera to be directed to the second sound source SS2. Further, when the second sound source SS2 enters the photographic range, the robot 100 may output a sound or an image for response to the second sound source SS2.

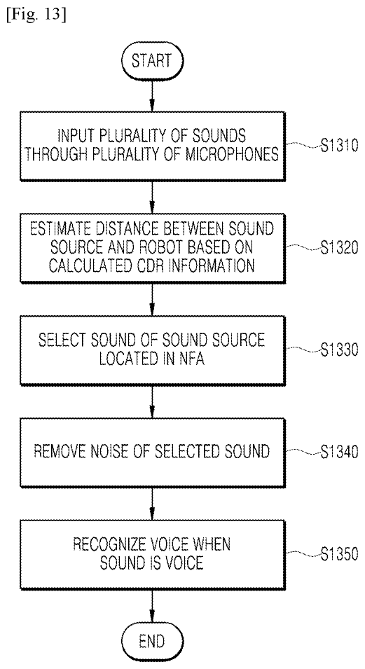

FIG. 13 is a view for explaining an operation of a robot which selects and uses a sound in a short distance among a plurality of sounds. FIG. 13 will be described also with reference to FIGS. 11 and 12.

For reference, when it is determined that CDR information of a sound which is input is out of the NFA, based on the estimated CDR information, the processor 190 may perform a far field model source localization on the sound and when it is determined that the CDR information is within the NFA, the processor 190 may perform a near field model source localization on the corresponding sound.

Here, in the far field, a distance between the robot 100 and the sound source is significantly long, a sound wave is a plane wave, the modeling is easy, but it is difficult to estimate the distance from the sound source. In the near field, a distance between the robot 100 and the sound source is similar to a distance between microphones, it is difficult to ignore a curve of the sound wave, it is easy to estimate the distance from the sound source, and the modeling is complicated.

That is, depending on whether the sound source is inside the NFA or out of the NFA, the robot 100 may perform different localization of the sound. Further, since the robot 100 may estimate distances from all sound sources, it is possible to specify arrangement angles of the sound sources and positions thoseof. Therefore, the robot 100 may recursively, selectively, or repeatedly use the far field model source localization and the near field model source localization. Specifically, the robot 100 may apply this method to perform the sound tracking. By doing this, a problem in that it is difficult to measure the distance from the sound source so that one field model source localization needs to be explicitly selected is solved. As an alternative embodiment, a reference area for distinguishing the sound localizations may be an area other than the NFA.

Referring to FIG. 13, the robot 100 receives a plurality of sounds through a plurality of microphones in step S1310.

The robot 100 may receive a sound of a first sound source SS1 disposed in the NFA and also receive a sound of a second sound source SS2 disposed in the STA. The robot 100 photographs the first sound source SS1.

In step S1320, the robot 100 estimates a distance between the sound source and the robot 100 based on the calculated CDR information.

The robot 100 may estimate that the first sound source SS1 is disposed in the NFA and the second sound source SS2 is disposed in the STA. Here, the robot 100 may set a near field model source for the sound of the first sound source SS1 and set a far field model source for the sound of the second sound source SS2 disposed in the STA.

By doing this, the robot 100 may estimate a sound direction of each sound source SS1 and SS2 and select only a sound of the sound source SS1 located in the NFA in step S1330.

The robot 100 may remove only a noise of the selected sound in step S1340.

Thereafter, when the sound from which the noise is removed is a voice, the robot 100 performs voice recognition in step S1350.

As described above, the robot 100 may exclude a sound in a long distance based on the distance information so that the selected sound may be more accurately and precisely detected. As a selective embodiment, the robot 100 may select only a sound in a long distance, or select both sounds in the long distance and the short distance and then selectively use a sound.

According to an exemplary embodiment, when both the first sound source SS1 and the second sound source SS2 are disposed in the NFA as illustrated in FIG. 12, the robot 100 may select a sound source under a predetermined condition. Therefore, a problem of the related art in that the robot 100 cannot recognize sounds which are simultaneously generated from a plurality of sound sources may be solved. As a selective embodiment, the robot 100 may simultaneously receive sounds of a plurality of sound sources disposed in NFA and remove noises/echoes from the simultaneously input sounds.

A module related to artificial intelligence may be additionally mounted in the robot 100. When the CDR information is estimated and the voice is recognized, the artificial intelligence module may increase estimation and recognition accuracy by means of its own thinking.

The artificial intelligence (AI) which is a field of computer engineering and information technology that researches how computers can do thinking, learning, self-development, etc. that can be done by human intelligence refers to a technique which allows a computer to imitate intelligence behavior of the human.

Further, the artificial intelligence does not exist by itself, but has a direct or indirect relationship a lot with other areas of the computer science. Specifically, in modern society, artificial intelligent elements are introduced to various fields of the information technology so that attempts to utilize the intelligent elements to solve the problems in that field are actively performed.

The robot 100 may figure out the sound sources through the machine learning, estimate CDR information of the sound of the sound source, and estimate a distance between the robot 100 and the sound. Further, the robot 100 may recognize the sound to learn and detect whose sound it is.

Here, the machine learning is a field of artificial intelligence and is a field of research which gives a computer an ability to learn without having an explicit program. Specifically, the machine learning may refer to a technique which studies and constructs a system which learns, predicts, and improves its own performance based on empirical data and an algorithm therefor. Algorithms of the machine learning may construct a specific model to derive prediction or decision based on the input data, rather than performing static program commands which are strictly determined.

Many machine learning algorithms have been developed for how to classify data in the machine learning. Representatively, a decision tree, a Bayesian network, a support vector machine (SVM), and an artificial neural network (ANN) are provided.

The decision tree is an analytical method which plots a decision rule with a tree structure to perform classification and prediction.

The Bayesian network is a model which represents a stochastic relation (conditional independence) between a plurality of variables with a graphical structure. The Bayesian network is appropriate for data mining through unsupervised learning.

The support vector machine is a model of supervised learning for pattern recognition and material analysis and is mainly used for classification or regression analysis.

The artificial neural network models an operation principle of biological neuron and connection relation between neurons and is an information processing system in which a plurality of neurons which is referred to as nodes or processing elements is connected with a layered structure.

The artificial neural network is a model used for machine learning and is a statistical learning algorithm which is inspired by neural networks in the biology (especially, the brain of animals' central nervous system) in machine learning and cognitive science.

Specifically, the artificial neural network may refer to an entire model having a problem solving ability by changing a coupling strength of synapse through the learning by artificial neurons (nodes) which form a network by the synapse connection. The term “artificial neural network” may be interchangeably used with the term “neural network”.

The artificial neural network may include a plurality of layers and each of the layers may include a plurality of neurons. Further, the artificial neural network may include a synapse which connects the neurons.

Generally, the artificial neural network may be defined by the following three factors: (1) a connection pattern between neurons of different layers, (2) a learning process of updating a weight of connection, and (3) an activation function which generates an output value from a weighted sum for an input received from a previous layer.

The artificial neural network may include network models such as a deep neural network (DNN), a recurrent neural network (RNN), a bidirectional recurrent deep neural network (BRDNN), a multilayer perceptron (MLP), and a convolutional neural network (CNN), but is not limited thereto.

The artificial neural network is divided into a single-layer neural network and a multi-layer neural network depending on the number of layers. A general single layer neural network is configured by an input layer and an output layer. Further, a general multi-layer neural network is configured by an input layer, one or more hidden layers, and an output layer.

The input layer is a layer which receives external materials and the number of neurons of the input layer is equal to the number of input variables. The hidden layer is located between the input layer and the output layer and receives a signal from the input layer to extract a feature and transmit the feature to the output layer. The output layer receives a signal from the hidden layer and outputs an output value based on the received signal. The input signals for neurons are multiplied with respective corresponding connection strengths and then added. When the sum is larger than a threshold value of a neuron, the neuron is activated to output the obtained output value through the activation function.

In the meantime, the deep neural network which includes a plurality of hidden layers between the input layer and the output layer may be a representative artificial neural network which implements deep learning which is one of machine learning techniques. In the meantime, the term “deep learning” may be used interchangeably with the term “deep training”.

The artificial neural network may be trained using training data. Here, the learning (training) may refer to a process of determining a parameter of an artificial neural network using learning data to achieve a goal such as classification, regression, or clustering of input data. As a representative example of a parameter of the artificial neural network, there may be a weight which is applied to the synapse or bias which is applied to the neuron.

The artificial neural network which is trained by the training data may classify or cluster input data in accordance with a pattern of the input data. The artificial neural network which is trained using the training data may be referred to as a trained model in the present disclosure.

Next, a learning method of the artificial neural network will be described. The learning method of the artificial neural network may be largely classified into supervised learning, unsupervised learning, semi-supervised learning, and reinforcement learning.

The supervised learning is one method of machine learning to derive one function from training data. When a consecutive value is output among the functions derived as described above, it is referred to as regression and when a class of an input vector is predicted to be output, it is referred to as classification. During the supervised learning, in a state in which a label for the training data is given, the artificial neural network is trained.

Here, the label may refer to a correct answer (or a result value) which needs to be deduced by the artificial neural network when the training data is input to the artificial neural network. When the training data is input, the correct answer (or a result value) which needs to be deduced by the artificial neural network is referred to as a label or labeling data. Further, in the specification, when a label is set to training data for learning of the artificial neural network, it is referred to as labeling of the labeling data to the training data. In this case, the training data and the label corresponding to the training data configure one training set and the training set may be input to the artificial neural network.

In the meantime, the training data indicates a plurality of features and when the label is labeled to the training data, it means that a label is attached to a feature represented by the training data. In this case, the training data may represent the feature of an input object as a vector.

The artificial neural network may infer a function for a correlation between the training data and the labeling data using the training data and the labeling data. Further, a parameter of the artificial neural network may be determined (optimized) by evaluating a function inferred from the artificial neural network.

The unsupervised learning is one type of machine learning, but a label for the training data is not given.

Specifically, the unsupervised learning may be a learning method which trains the artificial neural network to find and classify patterns from the training data itself, rather than from the correlation between the training data and the label corresponding to the training data. Examples of the unsupervised learning may include clustering or independent component analysis. In this specification, the term “clustering” may be interchangeably used with the term “clustering”. Examples of the artificial neural network which uses unsupervised learning may include generative adversarial network (GAN) or autoencoder (AE).

The generative adversarial network is a machine learning method in which two different artificial intelligences such as a generator and a discriminator compete to improve the performance. In this case, the generator is a model which creates new data and may generate new data based on original data.

Further, the discriminator is a model which recognizes a pattern of the data and may serve to distinguish whether input data is original data or new data generated by the generator. Further, the generator receives data which does not deceive the discriminator to learn and the discriminator receives data which is deceived by the generator to learn. Therefore, the generator may evolve to deceive the discriminator as much as possible and the discriminator may evolve to well distinguish the original data from data generated by the generator.

The above-described present disclosure may be implemented in a program-recorded medium by a computer-readable code. The computer-readable medium includes all types of recording devices in which data readable by a computer system is stored. Examples of the computer-readable medium may include a hard disk drive (HDD), a solid state disk (SSD), a silicon disk drive (SDD), ROM, RAM, CD-ROM, a magnetic tape, a floppy disk, and an optical data storage device. Further, the computer may include the processor 190 of the robot 100.

Although a specific embodiment of the present invention has been described and illustrated above, the present invention is not limited to the described embodiment and it is understood by those skilled in the art that the present invention may be modified and changed in various specific embodiments without departing from the spirit and the scope of the present invention. Therefore, the scope of the present invention is not determined by the described embodiment but may be determined by the technical spirit described in the claims.

What is claimed is:

1. An operating method of a robot, the operating method comprising:
receiving a sound generated from a base sound source located in a sensible range of the robot through a plurality of microphones;
calculating reference coherent to diffuse power ratio (CDR) information corresponding to distance information regarding a distance measured between the base sound source and the robot; and
estimating CDR information of a sound corresponding to the distance from the robot, based on the calculated reference CDR information.

2. The operating method of a robot according to claim 1, further comprising:
receiving a sound generated from a predetermined sound source which is out of a photographic range of the robot through the plurality of microphones;
calculating CDR information of an input sound;
estimating a position of the predetermined sound source based on the calculated CDR information and the estimated CDR information; and
performing a specific interaction operation when the estimated position of the predetermined sound source is within an interactable range with the robot.

3. The operating method of a robot according to claim 2, wherein the performing of a specific interaction operation includes:
changing a photographing direction of the robot so that the predetermined sound source enters the photographic range of the robot.

4. The operating method of a robot according to claim 3, wherein the performing of a specific interaction operation includes:
outputting a sound or an image for response to the predetermined sound source when the position of the predetermined sound source enters within the photographic range of the robot.

5. The operating method of a robot according to claim 1, further comprising:
setting at least one area of a near field area NFA where interaction with the sound source is performed, a sound tracking area STA where the sound of the sound source is tracked, and a far field area FFA, with respect to the robot, based on the distance information regarding the distance from the robot.

6. The operating method of a robot according to claim 5, further comprising:
determining sound output intensities corresponding to the respective areas when it is estimated that the sound source is located in one of the areas, based on the CDR information of the sound generated from the sound source.

7. The operating method of a robot according to claim 5, further comprising:
holding an operation of tracking the sound of the sound source when it is estimated that the sound source is located in the FFA based on the CDR information of the sound generated from the sound source.

8. The operating method of a robot according to claim 7, further comprising:
tracking the sound of the sound source when it is estimated that the sound source moves from the FFA to the STA.

9. The operating method of a robot according to claim 8, further comprising:
performing an operation for interaction with the sound source when it is estimated that the sound source moves from the STA to the NFA.

10. The operating method of a robot according to claim 1, further comprising:
generating a sound map which reflects a distance from one or more sound sources based on the distance information regarding the distance from the robot; and
updating the sound map based on the changed position when the position of the robot is changed.

11. An operating method of a robot, the operating method comprising:
receiving a sound of a base sound source in a first position within a sensible range of the robot through a plurality of microphones;
calculating first reference coherent to diffuse power ratio (CDR) information corresponding to distance information regarding a distance measured between the base sound source in the first position and the robot;
receiving a sound of the base sound source in a second position through the plurality of microphones when the base sound source moves to the second position;
calculating second reference coherent to diffuse power ratio (CDR) information corresponding to distance information regarding a distance measured between the base sound source in the second position and the robot; and
estimating CDR information of a sound corresponding to a distance from the robot, based on the calculated first and second reference CDR information.

12. A robot, comprising:
a distance sensing sensor;
an inputter which includes a plurality of microphones and receives an audio signal;
an outputter which includes a display; and
a processor which obtains a sound of a base sound source disposed in a sensible range of the distance sensing sensor through the plurality of microphones and processes the sound of the base sound source;
wherein the processor measures a distance between the robot and the base sound source using the distance sensing sensor, calculates reference CDR information corresponding to the measured distance information, and estimates the CDR information of a sound corresponding to the distance from the robot based on the calculated reference CDR information.

13. The robot according to claim 12, wherein the processor obtains a sound generated from a predetermined sound source which is out of a photographic range of the robot through the plurality of microphones, calculates CDR information of the obtained sound, estimates a position of the predetermined sound source based on the calculated CDR information and the estimated CDR information, and performs a specific interaction operation when the estimated position of the predetermined sound source is within an interactable range with the robot.

14. The robot according to claim 13, wherein the inputter includes a camera, and the processor changes a photographing direction of the camera so that the predetermined sound source enters within the photographic range of the robot.

15. The robot according to claim 14, wherein the outputter includes a speaker and when the position of the predetermined sound source enters the photographic range of the camera, the processor outputs a sound for response to the predetermined sound source through the speaker.

16. The robot according to claim 13, wherein the display displays an item representing a virtual human face shape and the processor controls the display to perform a specific interaction with the predetermined sound source using the item.

17. The robot according to claim 12, wherein the processor generates a sound map to which a distance from one or more sound sources is reflected based on the distance information regarding the distance from the robot and updates the sound map based on the changed position when the position of the robot is changed.

18. The robot according to claim 12, wherein the inputter obtains a sound generated from a base sound source in a first position within a sensible range of the robot through the plurality of microphones and when the robot moves from the first position to a second position, obtains the sound generated from the base sound source through the plurality of microphones and when the distances between the base sound sources disposed in the first position and the second position and the robot are respectively measured, the processor calculates reference CDR information corresponding to the measured distance information and estimates CDR information of the sound corresponding to the distance from the robot, based on the calculated reference CDR information.

19. The robot according to claim 12, wherein when a plurality of sound sources generates a sound to the robot, the processor selects a sound which is generated from a sound source which is estimated as being at a most proximate distance and removes noises from the selected sound.
